(19) United States
(12) Patent Application Publication
(10) Pub. No.: US 2006/0082827 A1
(43) Pub. Date: Apr. 20, 2006

(54) Network printer to control a print queue and method thereof

(76) Inventors: Hoo-ran Lee, Seoul (KR); In-chang Park, Seoul (KR)

Correspondence Address: STANZIONE & KIM, LLP, 919 18TH STREET, N.W., SUITE 440, WASHINGTON, DC, 20006, US

(21) Appl. No.: 11/252,028

(22) Filed: Oct. 18, 2005

(30) Foreign Application Priority Data
Oct. 19, 2004 (KR) 2004-83610

(51) Int. Cl. G06F 3/12

(52) U.S. Cl. 358/1.15

(57) ABSTRACT

A network printer to control a print queue and a controlling method thereof. The network printer to control a print queue includes a communication interface, a print job manager and a print engine. The communication interface receives print job information for print scheduling from at least one host computer. The print job manager determines a print queue of the received print job information based on a predetermined reference scheduling rule, and requests the at least one host computer to transfer print data. The print engine prints the print data received from the host computer. The print queue is determined through two steps, thereby effectively performing the print.

### CROSS-REFERENCE TO RELATED APPLICATIONS

This application claims benefit under 35 U.S.C. §119 from Korean Patent Application No. 2004-83610, filed on Oct. 19, 2004, the entire content of which is incorporated herein by reference.

### BACKGROUND OF THE INVENTION

1. Field of the Invention

The present general inventive concept relates to a network printing system, and more particularly, to a network printer to control a print queue and a controlling method thereof, in which the print queue for a plurality of documents transferred from a plurality of host computers is determined according to print jobs information and a reference scheduling rule.

2. Description of the Related Art

In a conventional network printing system in which one printer is in communication with a plurality of host computers via a network such as a local area network, the printer sequentially processes print job data received from the plurality of host computers. Since the plurality of host computers share one printer, the network printing system increases utilization of the printer and thus provides an inexpensive office automation.

In the network printing system, when the printer connected via the network (referred to as “local printer”) is printing first print data transferred from a first host computer, the network printer occasionally receives a print command for second print data from a second host computer.

In this case, after the print operation for the first print data is completed, the network printer receives the second print data from the second host computer to print. The second host computer is maintained in a spooling state until the print operation of the first print data is completed. As a result, there is a problem in that the second host computer is required to wait for a long time.

Recently, the network printer includes a hard disk drive to alleviate the prolonged waiting time of the host computers. Specifically, a conventional network printer receives the second print data from the second host computer and temporarily stores the received second print data in the hard disk drive. However, manufacturing costs for the network printer having the hard disk drive are increased.

In addition, a conventional local network authorizes the network printer to print according to priority corresponding to the queue of printing requests. As such, a user of the second host computer should wait to print the second print job data until the first print job data is completed, even when the second print job data is urgent. In particular, when the first host computer desires to print a document with a number of pages, the user of the second host computer is required to wait for a long time to print the second print job data.

### SUMMARY OF THE INVENTION

The present general inventive concept provides a network printer and a controlling method thereof to control a print queue of a plurality of documents requested from a plurality of host computers.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a network printer to control a print queue, the network printer comprising a communication interface to receive print job information for print scheduling from at least one host computer, a print job manager to determine the print queue of the received print job information based on a reference scheduling rule, and to request the at least one host computer to transfer print data, and a print engine to print the print data received from the at least one host computer.

The print job information may be transferred through a first logical port of a desired protocol, and the print data may be transferred through a second logical port.

The at least one host computer connected to a network printer may include a printer driver to convert a document into the print data, and to create and output the print job information related to the print data, a print job scheduler to instruct the printer driver to transfer the print job information and the print data to the network printer through a first logical port and a second logical port, respectively, a language monitor to transfer the print data and the print job information output from the printer driver to the print job scheduler, and a host interface to communicate with the network printer through the first logical port and the second logical port in response to an instruction of the print job scheduler.

The printer driver may provide a user interface to designate a temporary scheduling rule. The print job scheduler inputs the print job information transferred from the language monitor to a print job list, realigns the print job list based on the temporary scheduling rule, and instructs the host interface to transfer the print job information having a highest priority to the network printer.

The reference scheduling rule and the temporary scheduling rule may be any one of shortest job first rule which is based on the number of pages for the print data, a first-come first-served, and a priority based rule, and the temporary scheduling rule is changeable.

The print job information may include a file name, a number of pages, and a volume of the print data, and an internet address of the at least one host computer that has output the print job information. The communication interface may be a network interface card.

The foregoing and/or other aspects of the present general inventive concept may also be achieved by providing a method of controlling a print queue comprising receiving print job information for print scheduling from at least one host computer, determining a print queue of the received print job information based on a reference scheduling rule, and requesting the at least one host computer to transfer print data, and printing the print data received from the at least host computer.

The method may further comprise converting a document into the print data and creating and outputting the print job information related to the print data, temporarily storing the print job information and the print data; transferring the temporarily stored print job information to a print job manager through a first logical port of a protocol and transferring the temporarily stored print job information to the print job manager through a second logical port of the protocol.

The outputting of the desired print job information may comprise providing a user interface to designate a temporary scheduling rule, and the transferring of the print job information to the print job manager comprises inputting the print job information to a print job list, realigning the print job list based on the temporary scheduling rule stored to set a temporary print queue, and transferring the print job information having highest priority among the set temporary print queue to the communication interface.

The print job information and the print data may be received through the first logical port and the second logical port of a network interface card, respectively.

The foregoing and/or other aspects of the present general inventive concept may also be achieved by providing a printing system to control a print queue, the printing system comprising a first host computer to generate a first print queue according to first print job information corresponding to first print data, a second host computer to generate a second print queue according to second print job information corresponding to second print data, and a printer to generate a printer queue according to the first and second print job information and a scheduling rule, and to print the first data and second data according to the printer queue.

The foregoing and/or other aspects of the present general inventive concept may also be achieved by providing a printing system to control a print queue, the system comprising a print job manager to receive first print job information and second print job information from first and second external host computers, to determine a printer queue according to the first and second print job information and a reference scheduling rule so that one of first print data and second print data corresponding to the first print job information and the second print job information, respectively, is printed according to the determined printer queue.

The foregoing and/or other aspects of the present general inventive concept may also be achieved by providing a printing system to control a temporary print queue, comprising a print job scheduler to receive first print job information and second print job information corresponding to first print data and second print data, respectively, when previous print data is output, and to determine the temporary print queue according to the first and second print job information and a temporary scheduling rule so that one of the first print job information and the second print job information is output according to the determined print queue.

The foregoing and/or other aspects of the present general inventive concept may also be achieved by providing a network printing system comprising at least two network devices to generate print data and print information for a plurality of print jobs, to order the print jobs in each network device in a first print job list according to a first scheduling rule using the print information, to send the print information of a first job on the first print list, to store the print data, and to send the print data upon request, and a network printer to receive the print information from the at least two network devices, to create a second print job list according to a second scheduling rule using the print information received from the at least two network devices, to request the print data corresponding to the print information according to the second job list from one of the at least two network devices, and to print the received print data.

The foregoing and/or other aspects of the present general inventive concept may also be achieved by providing a method of controlling a print job queue in a host computer, the method comprising creating print data and print information for at least one print job, storing the print data to be provided upon request, creating a primary print job queue using the print information according to a temporary scheduling rule, and transferring the print job information having the highest priority in the primary print queue to a network printer through a first logical port.

The foregoing and/or other aspects of the present general inventive concept may also be achieved by providing a method of controlling printer, the method comprising receiving printer job information corresponding to a plurality of printing job data, the method comprising receiving print job information through a first logical port, determining a printer print queue using the print job information and a reference scheduling rule, requesting the print data corresponding to the print information that is first in the printer print queue, receiving the print data through a second logical port, and printing the print data.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic view of a network printing system according to an embodiment of the present general inventive concept;

FIG. 2 is a block diagram schematically illustrating first through n^{th} host computers and a network printer in the network printing system of FIG. 1; and

FIGS. 3 and 4 are flowcharts illustrating a method of controlling a primary print queue and a secondary print queue of printing jobs, method performed by the network printing system of FIG. 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

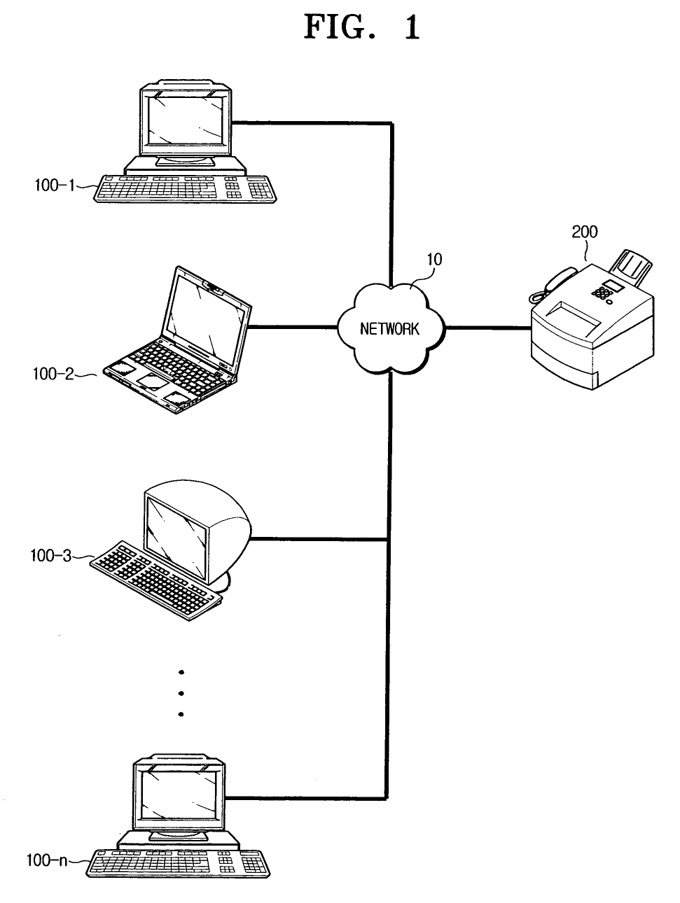

Referring to FIGS. 1 through 4, an embodiment of the present general inventive concept will be described in detail below. FIG. 1 is a schematic view of a network printing system according to an embodiment of the present general inventive concept. Referring to FIG. 1, first through n^{th} host computers 100-1, 100-2, 100-3, . . . 100-n are in communication with one network printer 200 via a network 10.

The first through n^{th} host computers 100-1, 100-2, 100-3, . . . 100-n may create and transfer print job data to the network printer 200. When there are a plurality of documents to be printed, a temporary print queue of the documents is determined in each of the first through n^{th} host computers 100-1, 100-2, 100-3, . . . 100-n, The printing job for the document having the highest position in the respective temporary print queue is submitted to the network printer 200.

If the first through n^{th} host computers 100-1, 100-2, 100-3, . . . 100-n request their printing jobs, the network printer 200 determines a print queue based on a predetermined reference scheduling rule, so as to print the printing j data according to the temporary print queues received from the first through n^{th} host computers 100-1, 100-2, 100-3, . . . 100-n.

The network 10 may be a local area network, a sharer such as HUB, or an internet network.

The network printer 20 can be used by network devices including a multifunction machine having a printing function.

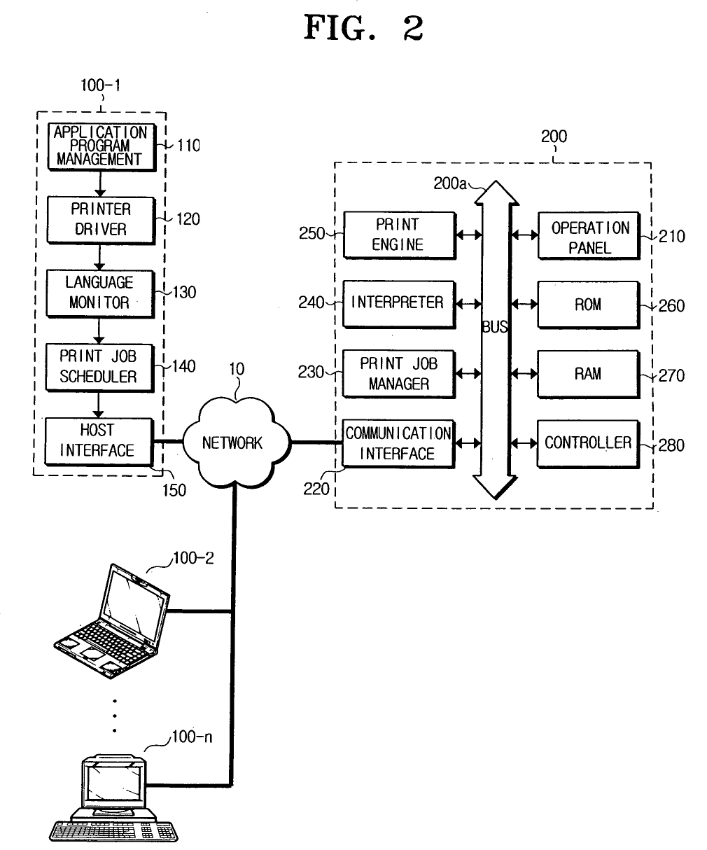

FIG. 2 is a block diagram schematically illustrating the first through the third host computers 100-1, 100-2, 100-3, . . . 100-n and the network printer 200 in the network printing system of FIG. 1.

Referring to FIGS. 1 and 2, the first host computer 100-1 includes an application program management 110, a printer driver 120, a language monitor 130, a print job scheduler 140, and a host interface 150.

The application program management 110 is an application program to prepare a document, an image, etc. After the document is prepared in the application program management 110, the application program management 110 transfers the prepared document, a volume of the document, a number of pages of the document, and a file name of the document to the printer driver 120.

The printer driver 120 converts the document into print data (i.e., printer file) using a printer driver program related to a network printer 200 to create print job information. The print data is data readable by the network printer 200, and may include a printer control language (PCL), a page description language (PDL), etc. The print job information may include a volume of print data, the number of pages, a file name, an internet protocol of the first host computer 100-1, a print request signal, etc.

Also, the printer driver 120 provides a user interface to allow the user to designate a temporary scheduling rule of the print jobs. The temporary scheduling rule is a rule used to determine the temporary print queue of the plurality of documents, in a case where there is a plurality of documents to be printed in the first host computer 100-1. The temporary scheduling rule may be a shortest job first (SJF) rule, a first-come first-served rule, or a priority based rule. The temporary print queue is determined based on the temporary scheduling rule selected by the user. The temporary print rule may be selected through the user interface displayed in the first host computer 100-1.

The SJF rule is a scheduling rule in which the shortest print job among the print jobs is printed first. The first-come first-served rule is a scheduling rule in which the print jobs are scheduled according to the order in which the printing jobs entered the queue of print requests. The priority based rule is a scheduling rule in which the print jobs are executed according to a level priority, which is selected by the user, among several levels such as a high level, a middle level, and a low level. Specifically, in the case of the priority based scheduling, the document designated by the user as having the high level is printed first. If two documents are designated as having the high level, the document that is first requested is printed first. The scheduling rule used by the host computers 100-1, 100-2, 100-3, . . . 100-n and the network printer 200 can be altered, that is, the scheduling are changeable.

An example in which the first host computer 100-1 determines the temporary print queue using the SJF rule will now be described.

The language monitor 130 transfers the print data and the print job information output from the printer drive 120 to the print job scheduler 140.

The print job scheduler 140 temporarily stores the print data and the print job information transferred from the language monitor 130 in a memory, for example, buffer (not shown). The print job scheduler 140 inputs the print job information into an existing print job list including existing print job information previously received from the language monitor 130, realigns the existing print job list based on the temporary scheduling rule set in the printer driver 120 and generates a new print job list including new print job information to determine the temporary print queue.

If the temporary print queue is determined, the new print job scheduler 140 instructs the host interface 150 to transfer the print job information having the highest priority among the determined temporary print queue to the network printer 200. The print job scheduler 140 instructs the host interface 150 to transfer the print job information using a first logical port of a desired protocol through the network 10.

For example, when a first print job information time1 of first print job information transferred from the language monitor 130 has 10 pages, a second print job information time2 of second print job information transferred next has 8 pages, and a third print job information time3 of third print job information transferred last has 3 pages, since the first host computer 100-1 uses the SJF rule, the temporary print queue is set in order of time3>time2>time1.

The print job scheduler 140 transfers the third print job information , which is requested last but has the smallest number of pages, to the network printer 200 through the first logical port (for example, No. 9000) according to the temporary print queue.

The host interface 150 transfers the first, second or third print job information having the highest priority to the network printer 200 through the first logical port using a desired protocol in response to the instruction of the print job scheduler 140 ) according to the temporary print queue.

After a predetermined time interval, if the network printer 200 requests the transfer of the print data corresponding to the transferred print job information, the print job scheduler 140 instructs the host interface 150 to transfer the requested print data, which is temporarily stored in the buffer (not shown), through a second logical port (for example, No. 8080 of TCP/IP).

Since the second through n^{th} host computers 100-2 through 100-n function substantially similar to the first host computer 100-1, the detailed description thereof will be omitted. However, the second host computer 100-2 may determine a second temporary print queue using the first-come first-served rule as the temporary scheduling rule, and the third host computer 100-3 may determine a third temporary print queue using the priority rule as the temporary scheduling rule.

The network printer 200 capable of controlling a printer print queue according to an embodiment of the present general inventive concept includes an operation panel 210, a communication interface 220, a print job manager 230, an interpreter 240, a print engine 250, a ROM 260, a RAM 270, and a controller 280. A bus 200a provides each block with a data transferring path.

The operation panel 210 has a plurality of input keys (not shown) to select and set functions supported by the network printer 200, and a display (not shown) to display an operating state of the network printer 200.

The communication interface 220 communicates with the first through n^{th} host computers 100-1,100-2, 100-3, . . . 100-n through the network 10. The communication interface 220 outputs the print job information and the print data transferred from the plurality of host computers 100-1, 100-2, 100-3, . . . 100-n to the print job manager 230. The communication interface 220 may use a network interface card.

When the print engine 250 performs a current printing operation of a print job, the print job manager 230 realigns the print job information transferred through the communication interface 220 and the printer print queue of the existing print job information previously received, based on a predetermined reference scheduling rule. When the current printing operation is completed, the print job manager 230 identifies the print job information corresponding to the first print job in the realigned printer print queue. The print job manager 230 requests one of the plurality of host computers 100-1, 100-2,100-3, . . . 100-n, that has provided the print job information in the first print job to transfer the corresponding print data.

The reference scheduling rule is a rule used when the printer print queue is set as described above. The network printer 200 may employ any one of the SJF rule, the first-come first-served rule, and the priority based rule. A default reference scheduling rule may be used as reference scheduling rule using a printer program. The rule to be employed in the network printer 200 may be altered according to a selection made by a user through the operation panel 210 or by changing the printer program. In the present embodiment, the network printer 200 determines the printer print queue using the SJF rule.

For example, when the network printer 200 sequentially receives print job information time4 having information of 50 pages from the second host computer 100-2 and print job information time5 having information of 3 pages from the first host computer 100-1 while performing the current printing operation, the print job manager 230 realigns the printer print queue including the print job information time4 and the print job information time5 based on the SJF rule. The print job manager 230 authorizes the print job information time5 of the higher priority to be placed on the printer print queue before the print job information time4, since the print job information time5 transferred later has fewer pages. After a predetermined time interval, if the current printing operation is completed, the print job manager 230 request the first host computer 100-1 that has output the print job information time5 to transfer the print data corresponding to the print job information time5. The network printer 200 prints the print data corresponding to the print job information time5 transferred from the first host computer 100-1.

The interpreter 240 interprets the print data transferred from the first host computer 100-1 through the second logical port of the desired protocol to convert the print data into a format supported by the network printer 200.

The print engine 250 prints the print data output from the interpreter 240 on a sheet of paper.

The ROM 260 stores various control programs required to achieve a function of the network printer 200, and the RAM 270 stores various data produced when the network printer 200 operates.

The controller 280 controls the whole operation of the network printer 200 according to the control program stored in the ROM 260. Specifically, the controller 280 controls the interpreter 240 and the print engine 250 to convert the received print data into the format supported by the printer.

Although the first host computer 100-1 may request the network printer to print a document of 20 pages later than a printing request submitted by the second host computer 100-2, the first host computer may be given priority to print first according to the temporary scheduling rule. The network printer 200 may give printing priority according to the reference scheduling rule, thereby printing faster a job from the first host computer 100-1 than a job from the second host computer 100-2. The network printer 200 may perform the determining operation of determining the printer print queue upon receiving the print job information from each of the host computers.

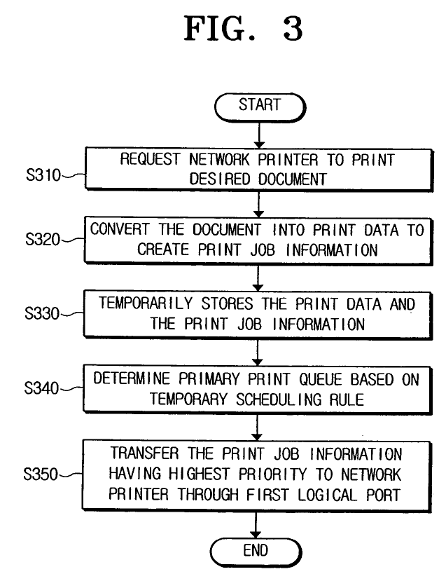

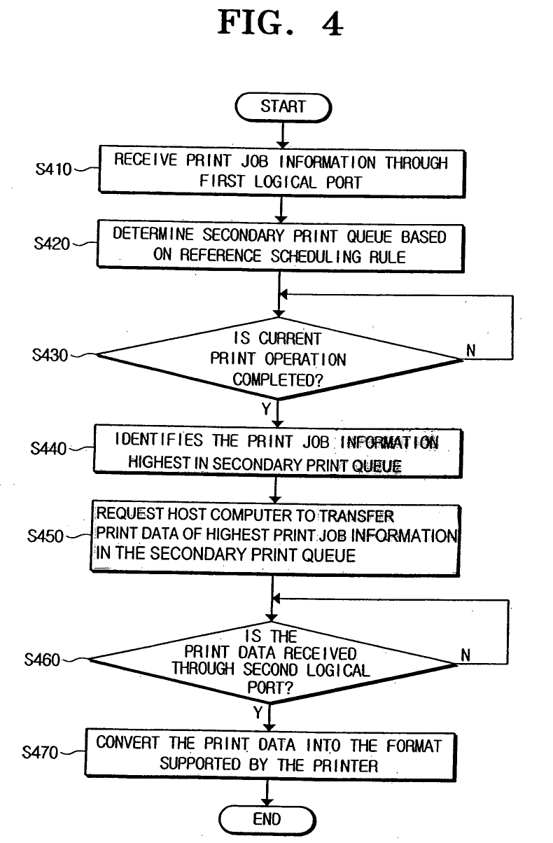

FIGS. 3 and 4 are flowcharts illustrating a method of controlling a primary print queue and a secondary print queue of printing jobs, method that is performed by the network printing system in FIG. 2.

Referring to FIGS. 1 through 3, if the first host computer 100-1 requests the network printer to print a document prepared by the first host computer (operation S310), the printer driver 120 converts the document into print data and creates print job information (operation S320).

After the operation S320, the language monitor 130 transfers the print data and the print job information output from the printer drive 120 to the print job scheduler 140, and the print job scheduler 140 temporarily stores the print data and the print job information transferred from the language monitor 130 (operation S330).

The print job scheduler 140 realigns a print job list based on the preset temporary scheduling rule to determine a primary print queue (the temporary print queue of the host computer 100-1) of the print job information transferred from the language monitor 130 (operation S340). The temporary scheduling rule may be the preset (default) scheduling rule or may be altered by a user. For example, the first host computer 100-1 may place first (highest) in the primary print queue the print job information corresponding to the print job having the smallest number of pages according to the SJF rule.

After the operation S340, the host interface 150 transfers the print job information highest (first) in the primary print queue to the network printer 200 through the first logical port of TCP/IP (operation S350).

Referring to FIGS. 1, 2 and 4, if the print job information is received through the first logical port, the communication interface 220 of the network printer 200 outputs the received print job information to the print job manager 230 (operation S410).

After the operation S410, the print job manager 230 determines a secondary print queue (the printer print queue) of the print job information received from the communication interface 220 based on the predetermined reference scheduling rule (operation S420). Specifically, if there is a previously received print job information before the print job information is received in operation S410, the previously received print job information is compared with the print job information received in operation S410 based on the predetermined reference scheduling rule such as SJF rule to determine the secondary print queue.

After the operation S420, if the current printing operation is completed, the print job manager 230 identifies the print job information corresponding to the highest (first) position in the secondary print queue determined in operation S420 (operations S430 and S440).

As a result, if the printing job information highest (first) in the secondary print queue is the printing information transferred from the first host computer 100-1, the print job manager 230 requests the first host computer to transfer the print data corresponding to the print job information (operation S450).

After the operation S450, the first host computer 100-1 transfers the print data corresponding to the print job information to the network printer 200 through the second logical port of TCP/IP.

Then, if the print data is received from the first host computer 100-1 through the second logical port, the interpreter 240 converts the print data into a format supported by the printer, and the print engine 250 prints the print data converted by the interpreter 240 (operations 460 and 470).

According to the above description, after the primary print queue is determined in each host computer, the network printer determines the secondary print queue, thereby shortening print job waiting time of the user having a shorter print job.

The scheduling rule used for determining the primary or the secondary print queue may be set and changed in every host computer and in the network printer, such that it can effectively perform the printing jobs even when there are insufficient printer resources.

In addition, after the network printer verifies the print job information to determine the secondary (printer) print queue, the network printer request the transmission of the print data. Therefore, the print data is not previously stored in the network printer, such that the network printer does not have to include a high capacity of storage medium, such as a hard disk drive and, therefore, lowering a cost of the network printer.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A network printer to control a print queue, the network printer comprising:
a communication interface to receive print job information for print scheduling from at least one host computer;
a print job manager to determine a print queue of the received print job information based on a reference scheduling rule, and to request the at least one host computer to transfer print data; and
a print engine to print the print data received from the at least one host computer.

2. The network printer as claimed in claim 1, wherein the print job information is transferred through a first logical port, and the print data is transferred through a second logical port.

3. The network printer as claimed in claim 1, wherein the at least one host computer comprises:
a printer driver to convert a document into the print data, and to create and output the print job information related to the print data;
a print job scheduler to instruct the printer driver to transfer the print job information and the print data to the network printer through a first logical port and a second logical port, respectively;
a language monitor to transfer the print data and the print job information output from the printer driver to the print job scheduler; and
a host interface to communicate with the network printer through the first logical port and the second logical port in response to an instruction of the print job scheduler.

4. The network printer as claimed in claim 3, wherein:
the printer driver comprises a user interface to designate a temporary scheduling rule; and
the print job scheduler inputs the print job information transferred from the language monitor to a print job list, realigns the print job list based on the temporary scheduling rule , and instructs the host interface to transfer the print job information having a highest priority in the print job list to the network printer.

5. The network printer as claimed in claim 4, wherein the reference scheduling rule and the temporary scheduling rule are any one of a shortest job first rule, a first-come first-served rule, and a priority based rule, and the temporary scheduling rule is changeable.

6. The network printer as claimed in claim 1, wherein the print job information includes a file name, a number of pages, and a volume of the print data, and an internet address of the at least one host computer.

7. The network printer as claimed in claim 1, wherein the communication interface comprises a network interface card.

8. A method of controlling a print queue, the method comprising:
receiving print job information for print scheduling from at least one host computer;
determining a print queue of the received print job information based on a reference scheduling rule, and requesting the at least one host computer to transfer print data; and
printing the print data received from the at least one host computer.

9. The method of as claimed in claim 8, further comprising:
converting a document into the print data and creating and outputting the print job information related to the print data;
temporarily storing the print job information and the print data;
transferring the temporarily stored print job information to a print job manager through a first logical port of a protocol; and
transferring the temporarily stored print job information to the print job manager through a second logical port of the protocol.

10. The method as claimed in claim 9, wherein:
the outputting of the print job information comprises providing a user interface to designate a temporary scheduling rule; and
the transferring of the print job information to the print job manager comprises inputting the print job information to a print job list, realigning the print job list based on the temporary scheduling rule stored to set a temporary print queue, and transferring the print job information having a highest priority among the set temporary print queue to a communication interface.

11. The method as claimed in claim 10, wherein the reference scheduling rule and the temporary scheduling rule are one of a shortest job first rule, a first-come first-served rule, and a priority rule, and the scheduling rules are changeable.

12. The method as claimed in claim 9, wherein the print job information and the print data are received through a first logical port and a second logical port of a network interface card, respectively.

13. The method as claimed in claim 8, wherein the print job information comprises a file name, a number of pages, and a volume of the print data, and an internet address of the at least one host computer outputting the print job information.

14. A printing system to control a print queue, comprising:
a first host computer to generate a first print queue according to first print job information corresponding to first print data;
a second host computer to generate a second print queue according to second print job information corresponding to second print data; and
a printer to generate a printer queue according to the first and second print job information and a reference scheduling rule, to print the first data and second data according to the printer queue.

15. The printing system as claimed in claim 14, wherein:
the first print job information comprises first sub-information corresponding to first sub-print data, and second sub-information corresponding to second sub-print data; and
the first host data creates the first print queue according to the first and second sub-information and a temporary scheduling rule.

16. The printing system as claimed in claim 15, wherein the first host computer outputs the second sub-information to the printer to the printer according to the first print queue so that the printer generates the printer queue according to second sub-information, the second print job information, and the scheduling rule.

17. A printing system to control a print queue, the system comprising:
a print job manager to receive first print job information and second print job information from first and second external host computers, to determine a printer queue according to the first and second print job information and a reference scheduling rule so that one of first print data and second print data corresponding to the first print job information and the second print job information, respectively, is printed according to the determined printer queue.

18. The printing system as claimed in claim 17, further comprising:
a print engine to print the one of the first print data and the second print data after printing previous print data.

19. The printing system as claimed in claim 18, wherein the print job manager determines the printer queue when receiving the first and second print job information during printing of the previous print data by the print engine.

20. The printing system as claimed in claim 17, wherein the print job manager receives the first print job information and second the second print job information in order while previous received data is printed, and determines the printer queue to print second print data corresponding to the second print job information after the printing of the of the previously received data is completed, and to print first print data corresponding to the first print job information after the second print data is printed.

21. The printing system as claimed in claim 17, wherein the print job manager requests one of the external first and second host computers to transmit the one of the first print data and the second print data, and requests the other one of the external first and second host computers to transmit the other one of the first print data and the second print data when the one of the first print data and the second print data is printed according to the determined printer queue.

22. The printing system as claimed in claim 17, wherein the first print data is printed after the second print data is printed according to the print queue, if the second print data has a higher priority then the first print data.

23. The printing system as claimed in claim 17, wherein the print job manager receives third print job information from one of the first and second external computers and a third external host computer, determines a new printer queue according to the reference scheduling rule, the third print job information and at least one of the first and second print job information.

24. A printing system to control a print queue, comprising:
a print job scheduler to receive first print job information and second print job information corresponding to first print data and second print data, respectively, when a previous print data is output, and to determine a temporary print queue according to the first and second print job information and a temporary scheduling rule so that one of the first print job information and the second print job information is output according to the determined temporary print queue.

25. A network printing system comprising:
at least two network devices to create print data and print information for a plurality of print jobs, to order the print jobs in each network device in a first print job list according to a first scheduling rule using the print information, to send the print information of a first job on the first print list and realign the first print job list, to store the print data, and to send the print data upon request; and
a network printer to receive the print information from the at least two network devices, to create a second print job list according to a second scheduling rule using the print information received from the at least two network devices, to request the print data corresponding to the print information according to the second job list from one of the at least two network devices, and to print the received print data.

26. The network printing system as claimed in claim 25, wherein:
the one of the at least two network devices that sent print data to the network printer sends the print information of the first job on the first print job list of the one of the at least two network devices to the network printer and realigns the first print job list; and the network printer realigns the printer print job queue according to any one timing rule defined by finishing printing the print data, a predetermined time interval, and finishing printing a page of the print data.

27. A method of controlling a print job queue in a host computer, the method comprising:
creating print data and print information for at least one print job;
storing the print data to be provided upon request;
creating a primary print job queue using the print information according to a temporary scheduling rule; and
transferring the print information of a first print job in the primary print queue to a network printer through a first logical port.

28. A method of controlling a printer queue of a printer receiving printer job information corresponding to a plurality of printing job data, the method comprising:
receiving print job information through a first logical port;
determining a printer print queue using the print job information and a reference scheduling rule;
requesting the print data corresponding to the print information that is first in the printer print queue;
receiving the print data through a second logical port; and
printing the print data.

29. The method as claimed in claim 28, further comprising:
converting the received print data into a format supported by the printer.
